(19) United States
(12) Patent Application Publication
(10) Pub. No.: US 2005/0041304 A1
(43) Pub. Date: Feb. 24, 2005

(54) Imaging optical system and optical apparatus using the same

(76) Inventors: Yoshimasa Suzuki, Kawasaki-shi (JP); Tetsuhide Takeyama, Tokyo-to (JP)

Correspondence Address: KENYON & KENYON, 1500 K STREET, N.W., SUITE 700, WASHINGTON, DC, 20005, US

(21) Appl. No.: 10/792,758

(22) Filed: Mar. 5, 2004

(30) Foreign Application Priority Data
Mar. 6, 2003 (JP) 2003-059741

(51) Int. Cl. G02B 15/14

(52) U.S. Cl. 359/687

(57) ABSTRACT

An imaging optical system at least includes a variable magnification optical system that includes, in order from the object side, a positive, first lens unit, a negative, second lens unit, a positive, third lens unit, a positive, fourth lens unit, and an aperture stop arranged between the third lens unit and the fourth lens unit, to change magnification by changing a distance between the first lens unit and the second lens unit, a distance between the second lens unit and the third lens unit, and a distance between the third lens unit and the fourth lens unit. The imaging optical system changes the magnification while keeping a constant object-to-image distance, and satisfies the following conditions in at least one magnification state:
|En|/L>0.4
|Ex|/|L/β|>0.4 where En is a distance from an object-side, first lens surface of the variable magnification optical system Z to the entrance pupil of the imaging optical system, L is the object-to-image distance of the imaging optical system, Ex is a distance from the image-side, last lens surface of the variable magnification optical system Z to the exit pupil of the imaging optical system, and β is a magnification of the entire imaging optical system.

### BACKGROUND OF THE INVENTION

1. Field of the Invention

The present invention relates to a variable magnification lens that can change imaging magnification in accordance with its application purpose, an optical system that can photograph a picture or the like recorded on a film with a magnification suitable for the film, and an optical apparatus such as an image converting apparatus using the same optical system.

2. Description of Related Art

Conventionally, imaging optical systems that can change imaging magnification have been proposed in, for example, Japanese Patent No. 2731481.

The optical system proposed in Japanese Patent No. 2731481 is configured as an optical system that is composed of, in order from the object side, a first lens unit having a positive refractive power, a second lens unit having a negative refractive power, and a third lens unit having a positive refractive power, that is both-side telecentric, and that can change imaging magnification while keeping a constant object-to-image distance.

### SUMMARY OF THE INVENTION

An imaging optical system according to the present invention at least has a variable magnification optical system that includes, in order from the object side, a first lens unit having a positive refractive power, a second lens unit having a negative refractive power, a third lens unit having a positive refractive power, a fourth lens unit having a positive refractive power, and an aperture stop arranged between the third lens unit and the fourth lens unit, to change imaging magnification by changing the distance between the first lens unit and the second lens unit, the distance between the second lens unit and the third lens unit, and the distance between the third lens unit and the fourth lens unit. The imaging optical system changes the imaging magnification while keeping a constant object-to-image distance thereof, and satisfies the following conditions in at least one magnification state in a change of the imaging magnification:
|En|/L>0.4
|Ex|/|L/β|>0.4
where En is a distance from an object-side, first lens surface of the variable magnification optical system to the entrance pupil of the imaging optical system, L is the object-to-image distance of the imaging optical system, Ex is a distance from the image-side, last lens surface of the variable magnification optical system to the exit pupil of the imaging optical system, and β is a magnification of the entire imaging optical system.

Also, the imaging optical system according to the present invention preferably satisfies the following conditions:
1.0<MAXFNO<8.0
|ΔFNO/Δβ|<5
where MAXFNO is a brightest object-side F-number in a change of the imaging magnification of the imaging optical system, ΔFNO is a difference between an object-side F-number under the minimum magnification of the entire system of the imaging optical system and an object-side F-number under the maximum magnification of the entire system of the imaging optical system, and Δβ is a difference between the minimum magnification of the entire system of the imaging optical system and the maximum magnification of the entire system of the imaging optical system.

Also, the imaging optical system according to the present invention preferably is such that the most object-side lens of the second lens unit is composed of a negative meniscus lens.

Also, the imaging optical system according to the present invention preferably is such that the second lens unit is composed of, in order from the object side, a negative lens and a positive lens.

Also, the imaging optical system according to the present invention preferably is such that the second lens unit is composed of, in order from the most object side, a negative lens, a positive lens and a negative lens.

Also, an optical apparatus according to the present invention includes the imaging optical system according to the present invention.

According to the present invention, it is possible to realize an imaging optical system that keeps a constant object-to-image distance with a small fluctuation of F-number even in a change of imaging magnification, and an optical apparatus using the same.

This and other objects as well as features and advantages of the present invention will become apparent from the following detailed description of the preferred embodiments when taken in conjunction with the accompanying drawings.

### BRIEF DESCRIPTION OF THE DRAWINGS

FIGS. 1A, 1B and 1C are sectional views taken along the optical axis to show the optical configuration of the first embodiment of the imaging optical system according to the present invention, showing the situations where the magnification is 0.3×, 0.4× and 0.5×, respectively.

FIGS. 2A, 2B and 2C show spherical aberration, astigmatism and distortion, respectively, of the imaging optical system of the first embodiment under the condition where an object point at an infinite distance is in focus with the imaging magnification of 0.4×.

FIGS. 3A, 3B and 3C are sectional views taken along the optical axis to show the optical configuration of the second embodiment of the imaging optical system according to the present invention, showing the situations where the magnification is 0.3×, 0.4× and 0.5×, respectively.

FIGS. 4A, 4B and 4C show spherical aberration, astigmatism and distortion, respectively, of the imaging optical system of the second embodiment under the condition where an object point at an infinite distance is in focus with the imaging magnification of 0.4×.

FIGS. 5A, 5B and 5C are sectional views taken along the optical axis to show the optical configuration of the third embodiment of the imaging optical system according to the present invention, showing the situations where the magnification is 0.3×, 0.4× and 0.5×, respectively.

FIGS. 6A, 6B and 6C show spherical aberration, astigmatism and distortion, respectively, of the imaging optical system of the third embodiment under the condition where an object point at an infinite distance is in focus with the imaging magnification of 0.4×.

FIGS. 7A, 7B and 7C are sectional views taken along the optical axis to show the optical configuration of the fourth embodiment of the imaging optical system according to the present invention, showing the situations where the magnification is 0.3×, 0.4× and 0.5×, respectively.

FIGS. 8A, 8B and 8C show spherical aberration, astigmatism and distortion, respectively, of the imaging optical system of the fourth embodiment under the condition where an object point at an infinite distance is in focus with the imaging magnification of 0.4×.

FIGS. 9A, 9B and 9C are sectional views taken along the optical axis to show the optical configuration of the fifth embodiment of the imaging optical system according to the present invention, showing the situations where the magnification is 0.3×, 0.4× and 0.5×, respectively.

FIGS. 10A, 10B and 10C show spherical aberration, astigmatism and distortion, respectively, of the imaging optical system of the fifth embodiment under the condition where an object point at an infinite distance is in focus with the imaging magnification of 0.4×.

FIG. 11 is a schematic diagram that shows one embodiment of a telecine apparatus using the imaging optical system according to the present invention.

FIG. 12 is a schematic configuration diagram that shows one embodiment of a height measurement apparatus using the imaging optical system according to the present invention.

### DETAILED DESCRIPTION OF THE PREFERRED EMBODIMENTS

Preceding the description of the embodiments, the function and effect of the present invention will be explained below.

In the imaging optical system according to the present invention, the variable magnification optical system is composed of four lens-units of positive-negative-positive-positive power arrangement. Lens units disposed before (on the object side of) the stop are composed of a first lens unit having a positive refractive power, a second lens unit having a negative refractive power, and a third lens unit having a positive refractive power, and form a lens system having a positive refractive power as a whole. A fourth lens unit disposed after (on the image side of) the stop is configured as a lens system having a positive refractive power. The aperture stop is arranged between the third lens unit and the fourth lens unit.

Also, the imaging optical system according to the present invention is configured to change the imaging magnification while keeping a constant object-to-image distance. That is, the imaging optical system of the present invention is an optical system having a fixed conjugate length.

Also, the imaging optical system according to the present invention is configured to satisfy the following conditions (1) and (2) at least in one magnification state in a change of the imaging magnification, to be both-side telecentric:
|En|/L>0.4 (1)
|Ex|/|L/β|>0.4 (2)
where En is a distance from an object-side, first lens surface of the variable magnification optical system to the entrance pupil of the imaging optical system, L is the object-to-image distance of the imaging optical system, Ex is a distance from the image-side, last lens surface of the variable magnification optical system to the exit pupil of the imaging optical system, and β is a magnification of the entire imaging optical system.

The imaging optical system according to the present invention has a configuration in which the stop is arranged at a focal position of the lens system composed of the first to third lens units (having a positive refractive power as a whole) disposed on the object side thereof. This configuration causes an entrance pupil, which is an image of the stop, to be projected on an infinite distance. As a result, the imaging optical system according to the present invention is formed as an object-side telecentric optical system.

Also, the configuration is made so that the stop is positioned at a focal position of the lens system composed of the fourth lens unit (having a positive refractive power) disposed on the image side thereof. This configuration causes an exit pupil, which is an image of the stop, to be projected on an infinite distance. As a result, the projecting optical system according to the present invention is formed as an image-side telecentric optical system.

In the imaging optical system according to the present invention thus configured, the second lens unit having a negative refractive power and the third lens unit having a positive refractive power are given a role as a multivariator. Whereby, it is possible to change the compound focal length of the first to third lens units, which are disposed on the object side of the stop.

Also, in the imaging optical system according to the present invention, the configuration is made so that the stop is arranged between the third lens unit and the fourth lens unit having a positive refractive power. Also, the third lens unit, which is disposed on the image side of the stop, is not given a magnification changing function. Even if photographing magnification is changed, the position of the stop is substantially fixed with its movement being limited as much as possible. In such a configuration where the position of the stop is always in the vicinity of the focal position of the fourth lens unit, it is possible to change the photographing magnification while maintaining the exit-side telecentricity and a constant imaging F-number.

However, in order to maintain the object-side telecentricity and to fix the conjugate length while keeping a constant F-number in a change of the photographing magnification, it is necessary to satisfy the following conditions.

First, it is necessary to put the position of the stop at the compound focal position of the first to third lens units, which are disposed on the object side of the stop, even in a magnification change.

Second, it is necessary to keep a distance from the object surface to the stop surface substantially constant even in a magnification change.

If lens units with positive-negative-positive power arrangement as in the conventional examples were modified to have positive-negative-negative-positive power arrangement by dividing the lens unit having a negative refractive power into lens units with negative-negative power arrangement, a good balance regarding refractive power arrangement would collapse, to increase chromatic aberration of magnification and distortion.

In contrast, if the lens units with positive-negative-positive power arrangement is modified by dividing the lens unit into two lens units with negative-positive refractive powers to form a four-lens-unit configuration of positive-negative-positive-positive power arrangement as in the present invention, generation of aberrations can be made small.

In a case of the both-side telecentric optical system, even if magnification is changed, off-axis rays at the stop position are substantially parallel with the optical axis. In addition, since the only one lens unit that is disposed on the image side of the stop is the fourth lens unit, which is not movable, the focal length is kept constant. Therefore, fluctuation of image-side F-number in accordance with a magnification change is small and thus it is not necessary to adjust brightness of the camera even if magnification is changed.

Also, the object-side telecentric configuration as in the imaging optical system according to the present invention has the following merits. The merits will be explained in terms of a telecine apparatus (scanner for movies). The telecine apparatus is an apparatus to digitalize a movie film. The telecine apparatus is configured to illuminate the film by an illumination optical system and to pickup the image by a solid-state image sensor such as a CCD via an imaging optical system.

If the imaging optical system of the telecine apparatus is configured to be object-side telecentric as the imaging optical system according to the present invention is, pupil coincidence of the illumination system with the imaging system can be easily established and thus loss of light amount is small. Also, magnification variation on the image surface caused by disturbance of film planeness can be made small.

Also, the image-side telecentric configuration as in the imaging optical system according to the present invention has the following merits.

The merits will be explained in terms of so-called multiplate camera using image sensors for respective colors such as RGB. In general, the multiplate camera uses a color separation prism. This prism is configured to provide a separation interference film to split light by wavelength, namely, a dichroic film, on a cemented surface thereof. If the exit pupil is positioned close to the image surface, the incident angle of a chief ray as incident on the interference film should vary in accordance with an image point on the image surface. As a result, optical path length corresponding to film thickness varies, to produce difference in color separation characteristic by field angle and difference in color reproductivity, that is, color shading occurs. However, in the imaging optical system of the multiplate camera, the image-side telecentric configuration as in the present invention could prevent color shading from being produced.

Also, let us suppose that, for example, a solid-state image sensor such as CCD is arranged on the image side of the color separation prism. Here, if the exit pupil is positioned close to the image surface, the chief rays are obliquely incident on pixels. Thus, amount of light is reduced due to structures of CCD or the like, which intercept, mostly, off-axis incident rays, or, those other than light expected to enter the very light receiving section are incident. As a result, a state in which signals beside the essential data are output, or shading occurs. However, the image-side telecentric configuration as in the present invention could prevent color shading from being produced.

The imaging optical system according to the present invention is configured to be both-side telecentric. Accordingly, imaging magnification can be substantially determined by the ratio of the focal length of lens units on the object side of the stop to the focal length of lens units on the image side of the stop.

Also, the focal length of lens units on the object side of the stop is changed by changing the distance between the lens units on the object side of the stop. In this way, imaging magnification is changeable.

Also, in the imaging optical system according to the present invention, the first lens unit has a positive refractive power, to project an image of the stop, or the entrance pupil, to the infinite distance. In this configuration, chief rays on the object side of the first lens unit are refracted to be parallel with the optical axis, thereby to realize an object-side telecentric optical system.

Also, in the imaging optical system according to the present invention, the second lens unit has a negative refractive power and the third lens unit has a positive refractive power. The compound focal length of the second lens unit and the third lens unit is changed by changing the distance between the second lens unit and the third lens unit. That is, the second lens unit and the third lens unit are configured to function as a multivariator. In this way, movement of the second lens unit and the third lens unit can adjust the magnification to be appropriate for the size of the object.

Also, in the imaging optical system according to the present invention, the fourth lens unit has a positive refractive power, to project an image of the stop, or the exit pupil, to the infinite distance. In this configuration, chief rays on the image side of the fourth lens unit are made parallel with the optical axis, to thereby realize an object-side telecentric optical system.

Configuring an optical apparatus that uses the imaging optical system provided with the magnification changing function according to the present invention as set forth above has the following merits.

The merits will be explained in terms of the above-mentioned telecine apparatus. The telecine apparatus is an apparatus in which a video camera is attached to a film imaging apparatus, and is configured to digitalize an image on the film by converting it into video signals.

On the other hand, there are a plurality of movie film standards, by which the size of the image section of a film differs. The aspect ratio differs by film standard, as, for example, a 35 mm standard film has a size of 16 mm high×21.95 mm wide and a European wide film has a size of 11.9 mm high×21.95 mm wide. The size of an image pickup surface of a CCD is, in the case of a ⅔-type CCD solid-state image sensor, for example, 5.4 mm high×9.6 mm wide. In order to photograph an image with highly fine, large number of pixels, it is preferred to obtain image data using the CCD over the full imaging region thereof. To this end, it is necessary to change imaging magnification in accordance with film standard.

In a configuration of an optical apparatus using the imaging optical system according to the present invention, films of various standards can be digitalized, in the case of a telecine apparatus, for example. In this case, while the imaging magnification is changed, the conjugate length remains unchanged and fluctuation of the image-side F-number is kept small.

Also, if a multiplate camera is constructed using the imaging optical system according to the present invention, it is possible to reduce color shading caused by the color dispersion prism and shading of the CCD camera. In addition, it is possible to change photographing magnification without moving a camera, in compliance with film standard and size of the object, and, in addition, there is no need to adjust brightness even if magnification is changed.

Also, in the imaging optical system according to the present invention, for a better both-side telecentricity, it is preferred to satisfy the following conditions (1′), (2′) instead of Conditions (1), (2) above at least in one magnification state in a change of the imaging magnification:
|En|/L>0.8 (1′)
|Ex|/|L/β|>0.8 (2′)
where En is a distance from an object-side, first lens surface of the variable magnification optical system to the entrance pupil of the imaging optical system, L is the object-to-image distance of the imaging optical system, Ex is a distance from the image-side, last lens surface of the variable magnification optical system to the exit pupil of the imaging optical system, and β is a magnification of the entire imaging optical system.

Also, it is much preferred to satisfy the following conditions (1″) and (2″):
|En|/L>1.6 (1″)
|Ex|/|L/β|>1.6 (2″)
where En is a distance from an object-side, first lens surface of the variable magnification optical system to the entrance pupil of the imaging optical system, L is the object-to-image distance of the imaging optical system, Ex is a distance from the image-side, last lens surface of the variable magnification optical system to the exit pupil of the imaging optical system, and β is a magnification of the entire imaging optical system.

Also, in the imaging optical system according to the present invention, condition of F-number is specified by the following conditional expressions:
1.0<MAXFNO<8.0 (3)
|ΔFNO/Δβ|<5 (4)
where MAXFNO is a brightest object-side F-number in a change of the imaging magnification of the imaging optical system, ΔFNO is a difference between an object-side F-number under the minimum magnification of the entire system of the imaging optical system and an object-side F-number under the maximum magnification of the entire system of the imaging optical system, and Δβ is a difference between the minimum magnification of the entire system of the imaging optical system and the maximum magnification of the entire system of the imaging optical system.

It is noted that F-number is an amount to express brightness of optical systems. A smaller value of F-number indicates a brighter optical system.

Too small a value of F-number requires increase in number of lens elements for compensation for aberrations, to thereby cause the problem of increased entire length of the optical system. On the other hand, too large a value of F-number renders the optical system to be inappropriate for moving-picture photographing because of shortage of light amount.

Thus, satisfaction of Condition (3) means that the value of F-number is not too small or too large, to make it possible to eliminate the above mentioned problems, that is, too long an optical system and inappropriateness for moving-picture photographing.

Also, too large a value of |ΔFNO/Δβ| signifies a large fluctuation of image-side F-number in a magnification change and thus requires brightness adjustment of the camera.

On the other hand, satisfaction of Condition (4) makes the above-mentioned brightness adjustment of the camera dispensable.

It is noted that satisfying of the following conditions (3′), (4′) is preferable:
2.0<MAXFNO<5.6 (3′)
|ΔFNO/Δβ|<3 (4′)

Furthermore, it is much preferred to satisfy the following conditions (3″), (4″):
3.0<MAXFNO<4.0 (3″)
|ΔFNO/Δβ|<1 (4″)

In the imaging optical system according to the present invention, the most object-side lens in the second lens unit is constructed of a negative meniscus lens. A large part of rays are incident on the second lens unit as convergent rays. Therefore, if the most object-side lens of the second unit is constructed of a meniscus lens having a negative power on the object side, generation of aberrations can be prevented because the configuration nearly achieves the state of angle of minimum deflection for each bundle of rays.

Also, in the imaging optical system according to the present invention, it is preferred to compose the second lens unit of lenses having negative-positive power arrangement in order from the object side. Since the second lens unit has a negative refractive power as a whole, negative-positive power arrangement of the lenses can achieve compensation for off-axis chromatic aberrations.

Also, in the imaging optical system according to the present invention, the second lens unit may be composed of lenses having negative-positive-negative power arrangement. Since the second lens unit has a hegative refractive power as a whole, negative-positive-negative power arrangement of the lenses can achieve compensation for chromatic aberration of magnification.

In reference to the drawings, tThe embodiments of the present invention are described below.

First Embodiment

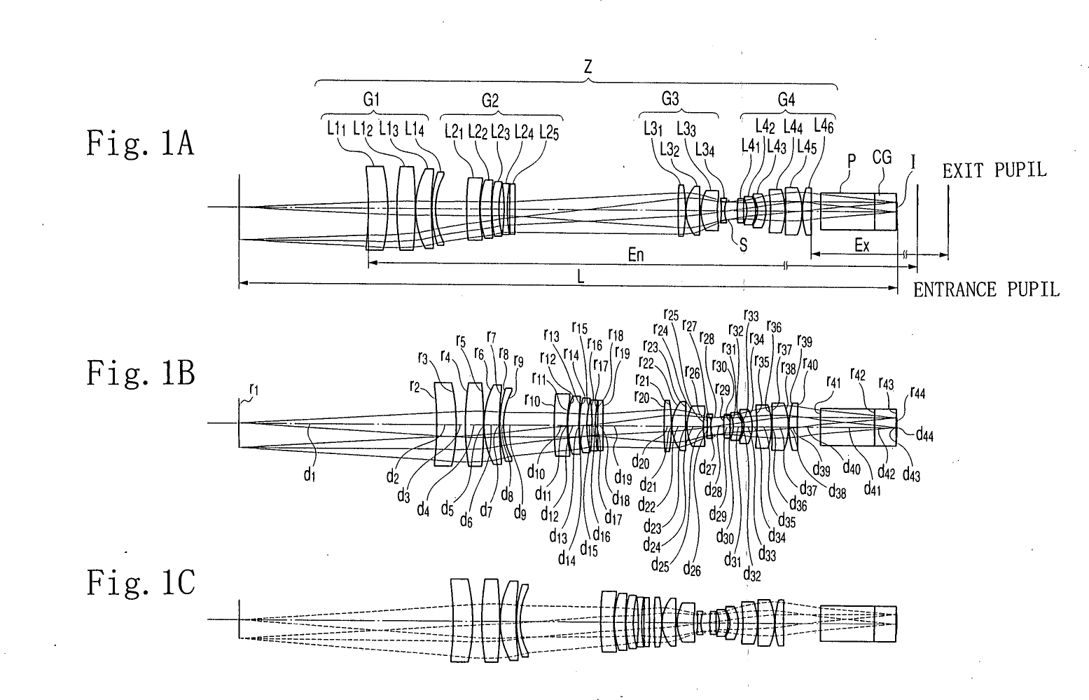

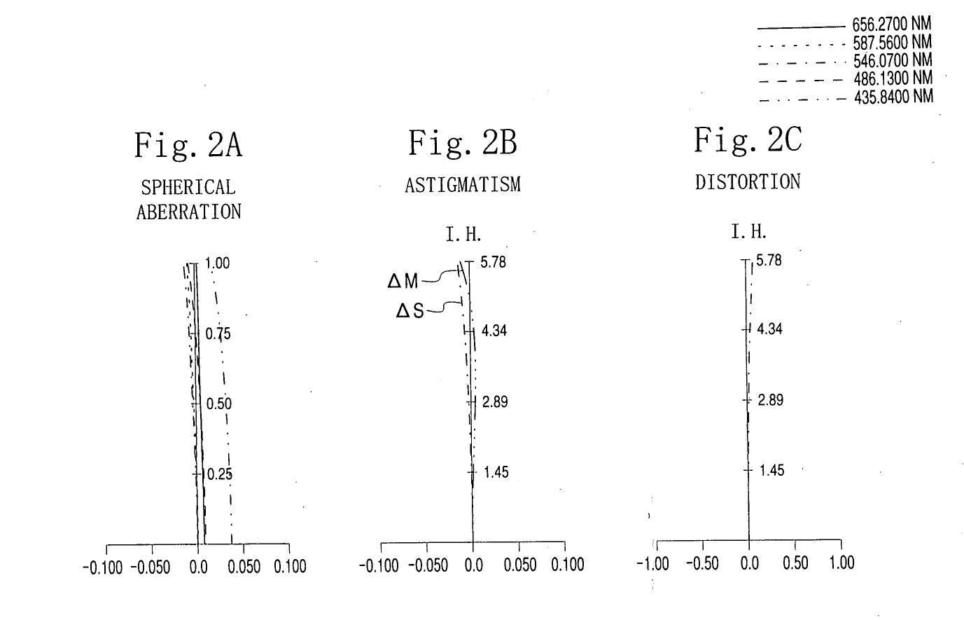

FIGS. 1A, 1B and 1C are sectional views taken along the optical axis to show the optical configuration of the first embodiment of the imaging optical system according to the present invention, showing the situations where the magnification is 0.3×, 0.4× and 0.5×, respectively. FIGS. 2A, 2B and 2C show spherical aberration, astigmatism and distortion, respectively, of the imaging optical system of the first embodiment under the condition where an object point at an infinite distance is in focus with the imaging magnification of 0.4×.

The imaging optical system of the first embodiment has a variable magnification optical system Z. In the drawings, the reference symbol P denotes a prism, the reference symbol CG denotes a cover glass, and the reference symbol I denotes an image pickup surface of an image pickup element.

The variable magnification optical system Z includes, in order from the object side toward the image side, a first lens unit G1 having a positive refractive power, a second lens unit G2 having a negative refractive power, a third lens unit G3 having a positive refractive power, an aperture stop S, and a fourth lens unit G4 having a positive refractive power.

The first lens unit G1 is composed of, in order from the object side, a positive meniscus lens L1₁ directing its concave surface toward the object side, a biconvex lens L1₂, a positive meniscus lens L1₃ directing its convex surface toward the object side, and a negative meniscus lens L1₄ directing its convex surface toward the object side.

The second lens unit G2 is composed of, in order from the object side, a negative meniscus lens L2₁ directing its convex surface toward the object side, a positive meniscus lens L2₂ directing its convex surface toward the object side, a negative meniscus lens L2₃ directing its convex surface toward the object side, a biconcave lens L2₄, and a biconvex lens L2₅.

The third lens unit G3 is composed of a biconvex lens L3₁, a positive meniscus lens L3₂ directing its convex surface toward the object side, a positive meniscus lens L3₃ directing its convex surface toward the object side, and a biconcave lens L3₄.

The fourth lens unit G4 is composed of a positive meniscus lens L4₁ directing its convex surface toward the object side, a negative meniscus lens L4₂ directing its concave surface toward the object side, a negative meniscus lens L4₃ directing its concave surface toward the object side, a positive meniscus lens L4₄ directing its concave surface toward the object side, a positive meniscus lens L4₅ directing its concave surface toward the object side, and a positive meniscus lens L4₆ directing its convex surface toward the object side.

In a magnification change from 0.3× through 0.5× under the condition where the object point at the infinite distance is in focus, the first lens unit G1 shifts toward the image side, the second lens unit G2 shifts toward the image side in such a manner that the distance thereto from the first lens unit G1 is widened, the third lens unit G3 shifts toward the object side along with the stop S, and the fourth lens unit G4 Shifts toward the object side in such a manner that the distance thereto from the third lens unit G3 is substantially constant for the earlier part of the travel and is slightly narrowed for the later part of the travel.

Also, the object-image distance in the magnification change is kept constant.

Numerical data of the optical members constituting the imaging optical system according to the first embodiment are shown below. In the numerical data, r₀, r₁, r₂, . . . denote radii of curvature of surfaces of optical elements as numbered from the object side, d₀, d₁, d₂, . . . denote thickness of optical elements or air spaces between the optical elements as numbered from the object side, nₑ₁, n_{d2}, . . . denote refractive indices of optical elements for e-line rays as numbered from the object side, vₑ₁, vₑ₂, . . . denote Abbe's number of optical elements as numbered from the object side.

It is noted that these symbols are commonly used in the numerical data for the subsequent embodiments also.

Numerical data 1

| | | |
|---|---|---|
| r₀ = ∞ (object) | | |
| d₀ = 30.000 | | |
| r₁ = ∞ (object surface) | | |
| d₁ = D₁ | | |
| r₂ = −185.4829 | | |
| d₂ = 11.959 | nₑ₂ = 1.48915 | νₑ₂ = 70.04 |
| r₃ = −109.8557 | | |
| d₃ = 5.570 | | |
| r₄ = 154.8363 | | |
| d₄ = 11.216 | nₑ₄ = 1.43985 | νₑ₄ = 94.53 |
| r₅ = −262.2803 | | |
| d₅ = 0.300 | | |
| r₆ = 50.9516 | | |
| d₆ = 9.569 | nₑ₆ = 1.43985 | νₑ₆ = 94.53 |
| r₇ = 172.0421 | | |
| d₇ = 0.373 | | |
| r₈ = 69.6835 | | |
| d₈ = 2.211 | nₑ₈ = 1.61639 | νₑ₈ = 44.15 |
| r₉ = 42.1219 | | |
| d₉ = D₉ | | |
| r₁₀ = 178.9534 | | |
| d₁₀ = 8.000 | nₑ₁₀ = 1.77621 | νₑ₁₀ = 49.36 |
| r₁₁ = 81.3069 | | |
| d₁₁ = 0.308 | | |
| r₁₂ = 52.3155 | | |
| d₁₂ = 6.847 | nₑ₁₂ = 1.64419 | νₑ₁₂ = 34.2 |
| r₁₃ = 139.6488 | | |
| d₁₃ = 0.300 | | |
| r₁₄ = 65.5333 | | |
| d₁₄ = 4.552 | nₑ₁₄ = 1.77621 | νₑ₁₄ = 49.36 |
| r₁₅ = 59.1193 | | |
| d₁₅ = 3.166 | | |
| r₁₆ = −111.4215 | | |
| d₁₆ = 2.000 | nₑ₁₆ = 1.77621 | νₑ₁₆ = 49.36 |
| r₁₇ = 88.9696 | | |
| d₁₇ = 1.376 | | |
| r₁₈ = 312.1101 | | |
| d₁₈ = 3.348 | nₑ₁₈ = 1.64419 | νₑ₁₈ = 34.2 |
| r₁₉ = −2131.3780 | | |
| d₁₉ = D₁₉ | | |
| r₂₀ = 248.9601 | | |
| d₂₀ = 4.511 | nₑ₂₀ = 1.43985 | νₑ₂₀ = 94.53 |
| r₂₁ = −86.0956 | | |
| d₂₁ = 0.300 | | |
| r₂₂ = 22.5325 | | |
| d₂₂ = 8.278 | nₑ₂₂ = 1.43985 | νₑ₂₂ = 94.53 |
| r₂₃ = 3017.3624 | | |
| d₂₃ = 0.916 | | |
| r₂₄ = 24.7714 | | |
| d₂₄ = 9.940 | nₑ₂₄ = 1.43985 | νₑ₂₄ = 94.53 |
| r₂₅ = 40.6479 | | |
| d₂₅ = 2.486 | | |
| r₂₆ = −62.1867 | | |
| d₂₆ = 2.000 | nₑ₂₆ = 1.61639 | νₑ₂₆ = 44.15 |
| r₂₇ = 15.3504 | | |
| d₂₇ = 2.539 | | |
| r₂₈ = ∞ (aperture stop) | | |
| d₂₈ = D₂₈ | | |
| r₂₉ = 76.3088 | | |
| d₂₉ = 3.835 | nₑ₂₉ = 1.43985 | νₑ₂₉ = 94.53 |
| r₃₀ = 330.4829 | | |
| d₃₀ = 1.983 | | |
| r₃₁ = −17.1121 | | |
| d₃₁ = 5.426 | nₑ₃₁ = 1.43985 | νₑ₃₁ = 94.53 |
| r₃₂ = −17.4388 | | |
| d₃₂ = 1.150 | | |
| r₃₃ = −13.9770 | | |
| d₃₃ = 5.067 | nₑ₃₃ = 1.61639 | νₑ₃₃ = 44.15 |
| r₃₄ = −21.9990 | | |
| d₃₄ = 2.937 | | |
| r₃₅ = −71.2381 | | |
| d₃₅ = 8.864 | nₑ₃₅ = 1.43985 | νₑ₃₅ = 94.53 |
| r₃₆ = −36.8748 | | |
| d₃₆ = 0.418 | | |
| r₃₇ = −402.7527 | | |
| d₃₇ = 9.972 | nₑ₃₇ = 1.43985 | νₑ₃₇ = 94.53 |
| r₃₈ = −35.1125 | | |
| d₃₈ = 0.300 | | |
| r₃₉ = 45.2992 | | |
| d₃₉ = 5.197 | nₑ₃₉ = 1.43985 | νₑ₃₉ = 94.53 |
| r₄₀ = 551.5811 | | |
| d₄₀ = D₃₇ | | |
| r₄₁ = ∞ | | |
| d₄₁ = 33.000 | nₑ₄₁ = 1.61173 | νₑ₄₁ = 46.30 |
| r₄₂ = ∞ | | |
| d₄₂ = 13.200 | nₑ₄₂ = 1.51825 | νₑ₄₂ = 63.93 |
| r₄₃ = ∞ | | |
| d₄₃ = 0.500 | | |
| r₄₄ = ∞ (image pickup surface) | | |
| d₄₄ = 0 | | |

| | | |
|---|---|---|
| 0.3× | 0.4× | 0.5× |

Zoom data

| | | | |
|---|---|---|---|
| D₁ | 49.5386 | 91.5843 | 101.5807 |
| D₉ | 19.1120 | 30.9242 | 49.2244 |
| D₁₉ | 99.6654 | 37.3724 | 3.0000 |
| D₂₈ | 5.2386 | 5.4335 | 3.0015 |
| D₄₀ | 5.8142 | 14.0543 | 22.5622 |

Parameters in conditional expressions

| | | | |
|---|---|---|---|
| magnification: β | | | |
| entrance pupil | 15652992.797 | 29106.293 | −2465.480 |
| position: En | | | |
| object-image | 403.280 | 403.280 | 403.280 |
| distance: L | | | |
| \|En\|/L | 38814.208 | 72.174 | 6.114 |
| exit pupil | −1309.993 | −1638.770 | −364.776 |
| position: Ex | | | |
| \|Ex\|/\|L/β\| | 0.975 | 1.625 | 0.452 |
| FNO | 3.500 | 3.513 | 3.567 |
| variation of | | | |
| FNO: ΔFNO 0.067 | | | |
| \|ΔFNO/Δβ\| 0.337 | | | |

Second Embodiment

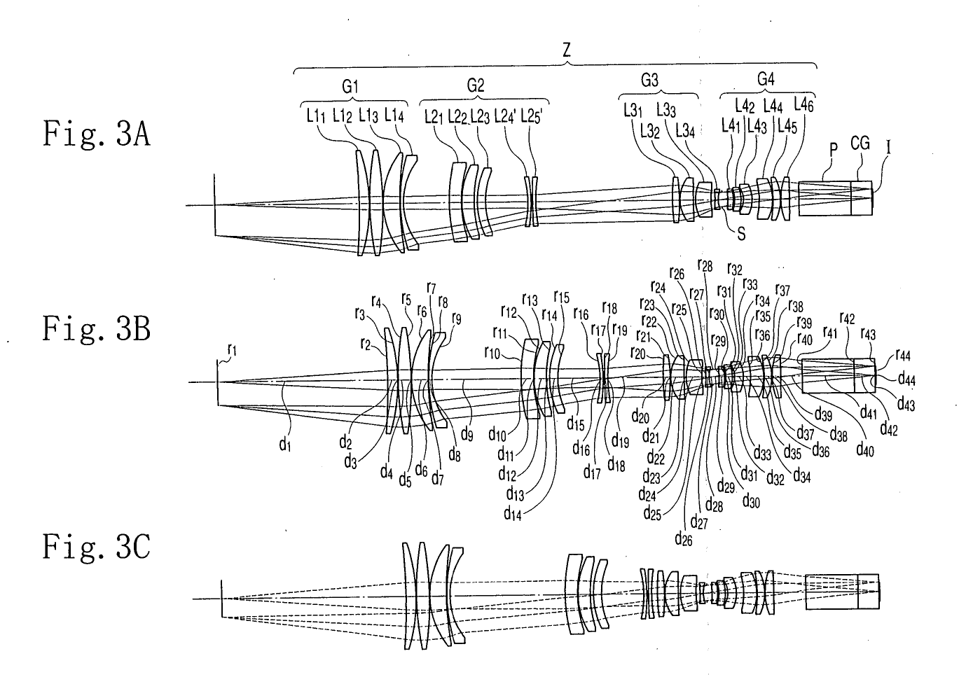

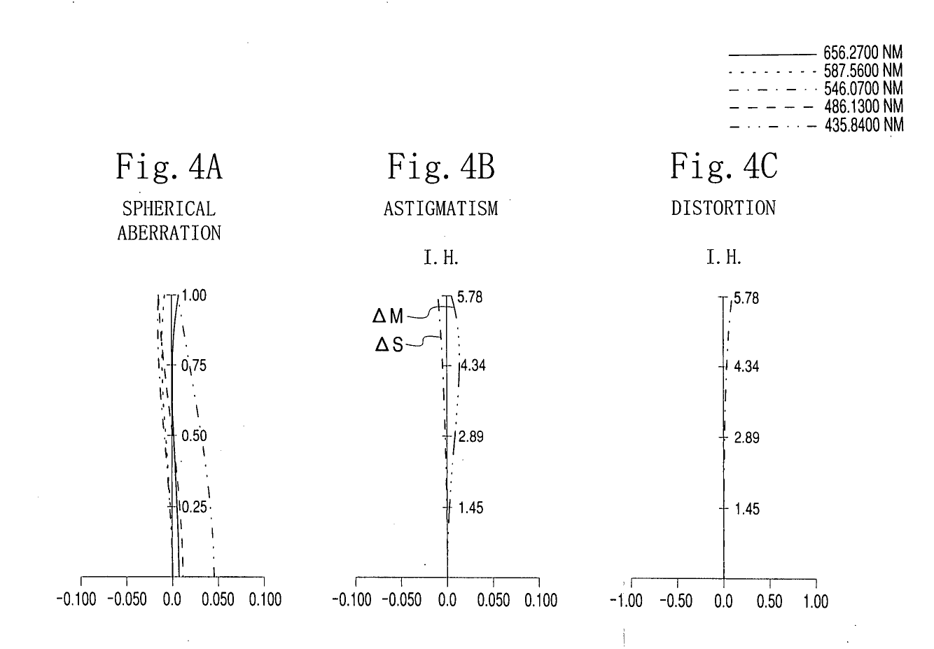

FIGS. 3A, 3B and 3C are sectional views taken along the optical axis to show the optical configuration of the second embodiment of the imaging optical system according to the present invention, showing the situations where the magnification is 0.3×, 0.4× and 0.5×, respectively. FIGS. 4A, 4B and 4C show spherical aberration, astigmatism and distortion, respectively, of the imaging optical system of the second embodiment under the condition where an object point at an infinite distance is in focus with the imaging magnification of 0.4×.

The imaging optical system of the second embodiment has a variable magnification optical system Z. In the drawings, the reference symbol P denotes a prism, the reference symbol CG denotes a cover glass, and the reference symbol I denotes an image pickup surface of an image pickup element.

The variable magnification optical system Z includes, in order from the object side toward the image side, a first lens unit G1 having a positive refractive power, a second lens unit G2 having a negative refractive power, a third lens unit G3 having a positive refractive power, an aperture stop S, and a fourth lens unit G4 having a positive refractive power.

The first lens unit G1 is composed of, in order from the object side, a positive meniscus lens L1₁ directing its concave surface toward the object side, a biconvex lens L1₂, a positive meniscus lens L1₃ directing its convex surface toward the object side, and a negative meniscus lens L1₄ directing its convex surface toward the object side.

The second lens unit G2 is composed of, in order from the object side, a negative meniscus lens L2₁ directing its convex surface toward the object side, a positive meniscus lens L2₂ directing its convex surface toward the object side, a negative meniscus lens L2₃ directing its convex surface toward the object side, a negative meniscus lens L2₄ directing its concave surface toward the object side, and a negative meniscus lens L2₅ directing its convex surface toward the object side.

The third lens unit G3 is composed of a biconvex lens L3₁, a positive meniscus lens L3₂ directing its convex surface toward the object side, a positive meniscus lens L3₃ directing its convex surface toward the object side, and a biconcave lens L3₄.

The fourth lens unit G4 is composed of a positive meniscus lens L4₁ directing its convex surface toward the object side, a negative meniscus lens L4₂ directing its concave surface toward the object side, a negative meniscus lens L4₃ directing its concave surface toward the object side, a positive meniscus lens L4₄ directing its concave surface toward the object side, a positive meniscus lens L4₅ directing its concave surface toward the object side, and a positive meniscus lens L4₆ directing its convex surface toward the object side.

In a magnification change from 0.3× through 0.5× under the condition where the object point at the infinite distance is in focus, the first lens unit G1 shifts toward the image side, the second lens unit G2 shifts toward the image side in such a manner that the distance thereto from the first lens unit G1 is widened, the third lens unit G3 shifts toward the object side along with the stop S, and the fourth lens unit G4 Shifts toward the object side in such a manner that the distance thereto from the third lens unit G3 is substantially constant for the earlier part of the travel and is slightly narrowed for the later part of the travel.

Also, the object-image distance in the magnification change is kept constant.

Numerical data of the optical members constituting the imaging optical system according to the second embodiment are shown below.

Numerical data 2

| | | |
|---|---|---|
| r₀ = ∞ (object) | | |
| d₀ = 30.000 | | |
| r₁ = ∞ (object surface) | | |
| d₁ = D₁ | | |
| r₂ = −364.4985 | | |
| d₂ = 6.402 | nₑ₂ = 1.48915 | νₑ₂ = 70.04 |
| r₃ = −107.3020 | | |
| d₃ = 0.300 | | |
| r₄ = 178.6180 | | |
| d₄ = 8.315 | nₑ₄ = 1.43985 | νₑ₄ = 94.53 |
| r₅ = −203.0477 | | |
| d₅ = 0.300 | | |
| r₆ = 50.1931 | | |
| d₆ = 10.666 | nₑ₆ = 1.43985 | νₑ₆ = 94.53 |
| r₇ = 186.6350 | | |
| d₇ = 0.300 | | |
| r₈ = 100.5125 | | |
| d₈ = 2.000 | nₑ₈ = 1.61639 | νₑ₈ = 44.15 |
| r₉ = 42.7231 | | |
| d₉ = D₉ | | |
| r₁₀ = 102.3576 | | |
| d₁₀ = 8.000 | nₑ₁₀ = 1.77621 | νₑ₁₀ = 49.36 |
| r₁₁ = 72.8237 | | |
| d₁₁ = 0.300 | | |
| r₁₂ = 47.6746 | | |
| d₁₂ = 7.818 | nₑ₁₂ = 1.64419 | νₑ₁₂ = 34.2 |
| r₁₃ = 76.2116 | | |
| d₁₃ = 2.063 | | |
| r₁₄ = 49.9019 | | |
| d₁₄ = 5.230 | nₑ₁₄ = 1.77621 | νₑ₁₄ = 49.36 |
| r₁₅ = 47.6164 | | |
| d₁₅ = 27.013 | | |
| r₁₆ = −60.0275 | | |
| d₁₆ = 2.000 | nₑ₁₆ = 1.77621 | νₑ₁₆ = 49.36 |
| r₁₇ = −94.0391 | | |
| d₁₇ = 0.998 | | |
| r₁₈ = 609.4854 | | |
| d₁₈ = 2.000 | nₑ₁₈ = 1.77621 | νₑ₁₈ = 49.36 |
| r₁₉ = 86.2723 | | |
| d₁₉ = D₁₉ | | |
| r₂₀ = 132.8427 | | |
| d₂₀ = 4.495 | nₑ₂₀ = 1.43985 | νₑ₂₀ = 94.53 |
| r₂₁ = −107.7589 | | |
| d₂₁ = 0.300 | | |
| r₂₂ = 22.4522 | | |
| d₂₂ = 8.545 | nₑ₂₂ = 1.43985 | νₑ₂₂ = 94.53 |
| r₂₃ = 619.2743 | | |
| d₂₃ = 1.331 | | |
| r₂₄ = 25.5056 | | |
| d₂₄ = 9.921 | nₑ₂₄ = 1.43985 | νₑ₂₄ = 94.53 |
| r₂₅ = 1.8348 | | |
| d₂₅ = 2.625 | | |
| r₂₆ = 61.8493 | | |
| d₂₆ = 2.000 | nₑ₂₆ = 1.61639 | νₑ₂₆ = 44.15 |
| r₂₇ = 14.4591 | | |
| d₂₇ = 2.382 | | |
| r₂₈ = ∞ (aperture stop) | | |
| d₂₈ = D₂₈ | | |
| r₂₉ = −63.7651 | | |
| d₂₉ = 3.573 | nₑ₂₉ = 1.43985 | νₑ₂₉ = 94.53 |
| r₃₀ = −25.5720 | | |
| d₃₀ = 0.813 | | |
| r₃₁ = −20.3612 | | |
| d₃₁ = 4.109 | nₑ₃₁ = 1.61639 | νₑ₃₁ = 44.15 |
| r₃₂ = −21.7926 | | |
| d₃₂ = 1.526 | | |
| r₃₃ = −12.8650 | | |
| d₃₃ = 5.515 | nₑ₃₃ = 1.61639 | νₑ₃₃ = 44.15 |
| r₃₄ = −20.7811 | | |
| d₃₄ = 4.613 | | |
| r₃₅ = −42.0412 | | |
| d₃₅ = 8.386 | nₑ₃₅ = 1.43985 | νₑ₃₅ = 94.53 |
| r₃₆ = −27.0291 | | |
| d₃₆ = 0.300 | | |
| r₃₇ = −70.0806 | | |
| d₃₇ = 4.735 | nₑ₃₇ = 1.43985 | νₑ₃₇ = 94.53 |
| r₃₈ = 29.7015 | | |
| d₃₈ = 0.300 | | |
| r₃₉ = 39.1665 | | |
| d₃₉ = 5.447 | nₑ₃₉ = 1.43985 | νₑ₃₉ = 94.53 |
| r₄₀ = −642.3086 | | |
| d₄₀ = D₃₇ | | |
| r₄₁ = ∞ | | |
| d₄₁ = 33.000 | nₑ₄₁ = 1.61173 | νₑ₄₁ = 46.30 |
| r₄₂ = ∞ | | |
| d₄₂ = 13.200 | nₑ₄₂ = 1.51825 | νₑ₄₂ = 63.93 |
| r₄₃ = ∞ | | |
| d₄₃ = 0.500 | | |
| r₄₄ = ∞ (image pick-up surface) | | |
| d₄₄ = 0 | | |

| | | |
|---|---|---|
| 0.3× | 0.4× | 0.5× |

Zoom data

| | | | |
|---|---|---|---|
| D₁ | 62.7408 | 79.0296 | 88.0608 |
| D₉ | 29.2995 | 57.1169 | 73.6357 |
| D₁₉ | 87.3101 | 35.2489 | 3.7467 |
| D₂₈ | 3.7702 | 4.0309 | 3.2195 |
| D₄₀ | 6.0557 | 13.7500 | 20.5137 |

Parameters in conditional expressions

| | | | |
|---|---|---|---|
| magnification: β | | | |
| entrance pupil position: En | −336.397 | −316.583 | −316.041 |
| object-image distance: L | 420.496 | 420.496 | 420.496 |
| \|En\|/L | 0.800 | 0.753 | 0.752 |
| exit pupil position: Ex | −469.551 | −547.096 | −357.274 |
| \|Ex\|/\|L/β\| | 0.335 | 0.520 | 0.425 |
| FNO | 3.500 | 3.546 | 3.599 |
| variation of FNO: ΔFNO 0.099 | | | |
| \|ΔFNO/Δβ\| 0.497 | | | |

Third Embodiment

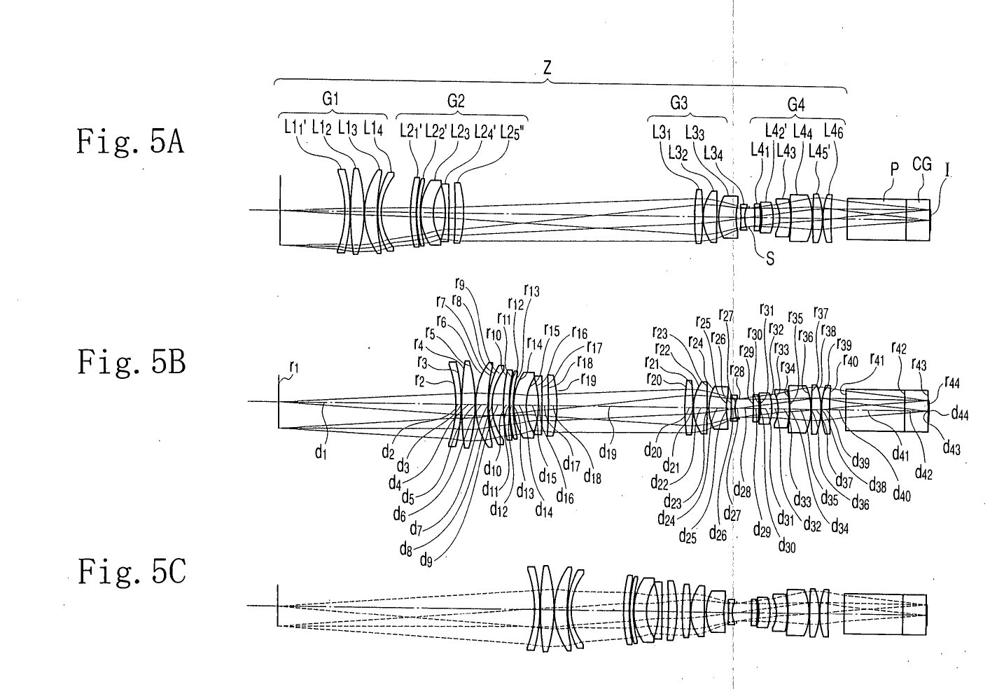

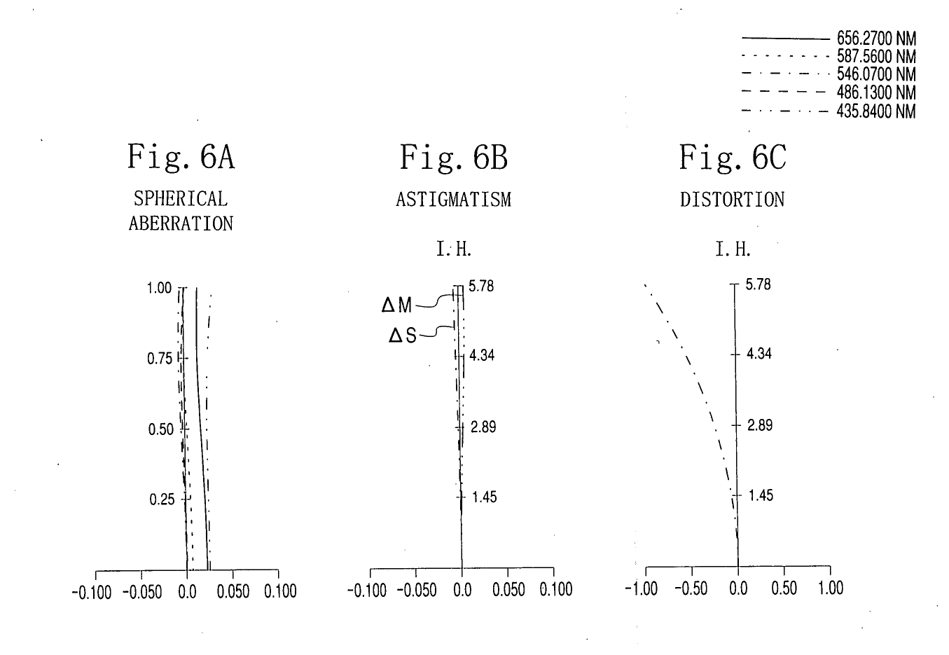

FIGS. 5A, 5B and 5C are sectional views taken along the optical axis to show the optical configuration of the third embodiment of the imaging optical system according to the present invention, showing the situations where the magnification is 0.3×, 0.4× and 0.5×, respectively. FIGS. 6A, 6B and 6C show spherical aberration, astigmatism and distortion, respectively, of the imaging optical system of the third embodiment under the condition where an object point at an infinite distance is in focus with the imaging magnification of 0.4×.

The imaging optical system of the third embodiment has a variable magnification optical system Z. In the drawings, the reference symbol P denotes a prism, the reference symbol CG denotes a cover glass, and the reference symbol I denotes an image pickup surface of an image pickup element.

The variable magnification optical system Z includes, in order from the object side toward the image side, a first lens unit G1 having a positive refractive power, a second lens unit G2 having a negative refractive power, a third lens unit G3 having a positive refractive power, an aperture stop S, and a fourth lens unit G4 having a positive refractive power.

The first lens unit G1 is composed of, in order from the object side, a positive meniscus lens L1₁ directing its concave surface toward the object side, a biconvex lens L1₂, a positive meniscus lens L1₃ directing its convex surface toward the object side, and a negative meniscus lens L1₄ directing its convex surface toward the object side.

The second lens unit G2 is composed of, in order from the object side, a positive meniscus lens L2₁ directing its convex surface toward the object side, a negative meniscus lens L2₂ directing its convex surface toward the object side, a negative meniscus lens L2₃ directing its convex surface toward the object side, a negative meniscus lens L2₄ directing its concave surface toward the object side, and a positive meniscus lens L2₅ directing its concave surface toward the object side.

The third lens unit G3 is composed of a biconvex lens L3₁, a positive meniscus lens L3₂ directing its convex surface toward the object side, a positive meniscus lens L3₃ directing its convex surface toward the object side, and a biconcave lens L3₄.

The fourth lens unit G4 is composed of a positive meniscus lens L4₁ directing its concave surface toward the object side, a positive meniscus lens L4₂ directing its concave surface toward the object side, a negative meniscus lens L4₃ directing its concave surface toward the object side, a positive meniscus lens L4₄ directing its concave surface toward the object side, a biconvex lens L4₅, and a positive meniscus lens L4₆ directing its convex surface toward the object side.

In a magnification change from 0.3× through 0.5× under the condition where the object point at the infinite distance is in focus, the first lens unit G1 shifts toward the image side, the second lens unit G2 shifts toward the image side in such a manner that the distance thereto from the first lens unit G1 is once narrowed and then widened, the third lens unit G3 shifts toward the object side along with the stop S, and the fourth lens unit G4 is fixedly positioned.

Also, the object-image distance in the magnification change is kept constant.

Numerical data of the optical members constituting the imaging optical system according to the third embodiment are shown below.

Numerical data 3

| | | |
|---|---|---|
| r₀ = ∞ (object) | | |
| d₀ = 30.000 | | |
| r₁ = ∞ (object surface) | | |
| d₁ = D₁ | | |
| r₂ = −60.9956 | | |
| d₂ = 2.975 | nₑ₂ = 1.61639 | νₑ₂ = 44.15 |
| r₃ = −88.4263 | | |
| d₃ = 0.300 | | |
| r₄ = 159.8538 | | |
| d₄ = 7.627 | nₑ₄ = 1.43985 | νₑ₄ = 94.53 |
| r₅ = −83.8571 | | |
| d₅ = 0.300 | | |
| r₆ = 39.6230 | | |
| d₆ = 7.182 | nₑ₆ = 1.43985 | νₑ₆ = 94.53 |
| r₇ = 95.5093 | | |
| d₇ = 0.300 | | |
| r₈ = 44.5588 | | |
| d₈ = 2.000 | nₑ₈ = 1.61639 | νₑ₈ = 44.15 |
| r₉ = 31.2746 | | |
| d₉ = D₉ | | |
| r₁₀ = 83.3742 | | |
| d₁₀ = 3.228 | nₑ₁₀ = 1.77621 | νₑ₁₀ = 49.36 |
| r₁₁ = 88.2696 | | |
| d₁₁ = 0.300 | | |
| r₁₂ = 68.2898 | | |
| d₁₂ = 2.000 | nₑ₁₂ = 1.64419 | νₑ₁₂ = 34.2 |
| r₁₃ = 65.0796 | | |
| d₁₃ = 0.300 | | |
| r₁₄ = 31.7567 | | |
| d₁₄ = 7.127 | nₑ₁₄ = 1.77621 | νₑ₁₄ = 49.36 |
| r₁₅ = 28.6423 | | |
| d₁₅ = 6.845 | | |
| r₁₆ = −48.7029 | | |
| d₁₆ = 2.000 | nₑ₁₆ = 1.77621 | νₑ₁₆ = 49.36 |
| r₁₇ = −937.0824 | | |
| d₁₇ = 3.623 | | |
| r₁₈ = −241.2268 | | |
| d₁₈ = 4.797 | nₑ₁₈ = 1.64419 | νₑ₁₈ = 34.2 |
| r₁₉ = −64.5833 | | |
| d₁₉ = D₁₉ | | |
| r₂₀ = 106.9088 | | |
| d₂₀ = 4.541 | nₑ₂₀ = 1.43985 | νₑ₂₀ = 94.53 |
| r₂₁ = −137.6997 | | |
| d₂₁ = 0.300 | | |
| r₂₂ = 24.0449 | | |
| d₂₂ = 7.713 | nₑ₂₂ = 1.43985 | νₑ₂₂ = 94.53 |
| r₂₃ = −4374.4986 | | |
| d₂₃ = 1.053 | | |
| r₂₄ = 24.8140 | | |
| d₂₄ = 9.839 | nₑ₂₄ = 1.43985 | νₑ₂₄ = 94.53 |
| r₂₅ = 34.8875 | | |
| d₂₅ = 2.750 | | |
| r₂₆ = −76.2043 | | |
| d₂₆ = 2.057 | nₑ₂₆ = 1.61639 | νₑ₂₆ = 44.15 |
| r₂₇ = 14.2775 | | |
| d₂₇ = 2.526 | | |
| r₂₈ = ∞ (aperture stop) | | |
| d₂₈ = D₂₈ | | |
| r₂₉ = −74.7334 | | |
| d₂₉ = 3.164 | nₑ₂₉ = 1.61639 | νₑ₂₉ = 44.15 |
| r₃₀ = −52.2948 | | |
| d₃₀ = 0.932 | | |
| r₃₁ = −30.4710 | | |
| d₃₁ = 6.337 | nₑ₃₁ = 1.43985 | νₑ₃₁ = 94.53 |
| r₃₂ = −25.1634 | | |
| d₃₂ = 3.617 | | |
| r₃₃ = −17.9934 | | |
| d₃₃ = 6.295 | nₑ₃₃ = 1.61639 | νₑ₃₃ = 44.15 |
| r₃₄ = −43.0415 | | |
| d₃₄ = 0.300 | | |
| r₃₅ = −72.3560 | | |
| d₃₅ = 11.816 | nₑ₃₅ = 1.43985 | νₑ₃₅ = 94.53 |
| r₃₆ = −30.9950 | | |
| d₃₆ = 0.300 | | |
| r₃₇ = 279.5492 | | |
| d₃₇ = 5.381 | nₑ₃₇ = 1.43985 | νₑ₃₇ = 94.53 |
| r₃₈ = −37.9972 | | |
| d₃₈ = 0.300 | | |
| r₃₉ = 39.8556 | | |
| d₃₉ = 4.501 | nₑ₃₉ = 1.43985 | νₑ₃₉ = 94.53 |
| r₄₀ = 162.8950 | | |
| d₄₀ = 9.171 | | |
| r₄₁ = ∞ | | |
| d₄₁ = 33.000 | nₑ₄₁ = 1.61173 | νₑ₄₁ = 46.30 |
| r₄₂ = ∞ | | |
| d₄₂ = 13.200 | nₑ₄₂ = 1.51825 | νₑ₄₂ = 63.93 |
| r₄₃ = ∞ | | |
| d₄₃ = 0.500 | | |
| r₄₄ = ∞ (image pick-up surface) | | |
| d₄₄ = 0 | | |

| | | |
|---|---|---|
| 0.3× | 0.4× | 0.5× |

Zoom data

| | | | |
|---|---|---|---|
| D₁ | 6.757 | 70.599 | 115.947 |
| D₉ | 16.509 | 6.383 | 29.704 |
| D₁₉ | 130.659 | 72.239 | 3.000 |
| D₂₈ | 3.204 | 7.908 | 8.478 |

Parameters in conditional expressions

| | | | |
|---|---|---|---|
| magnification: β | | | |
| entrance pupil position: En | −1416.328 | 1403.564 | 823.831 |
| object-image distance: L | 367.628 | 367.628 | 367.628 |
| \|En\|/L | 3.853 | 3.818 | 2.241 |
| exit pupil position: Ex | −358.983 | 842.952 | 640.719 |
| \|Ex\|/\|L/β\| | 0.293 | 0.917 | 0.871 |
| FNO | 3.500 | 3.546 | 3.552 |
| variation of FNO: ΔFNO 0.052 | | | |
| \|ΔFNO/Δβ\| 0.259 | | | |

Fourth Embodiment

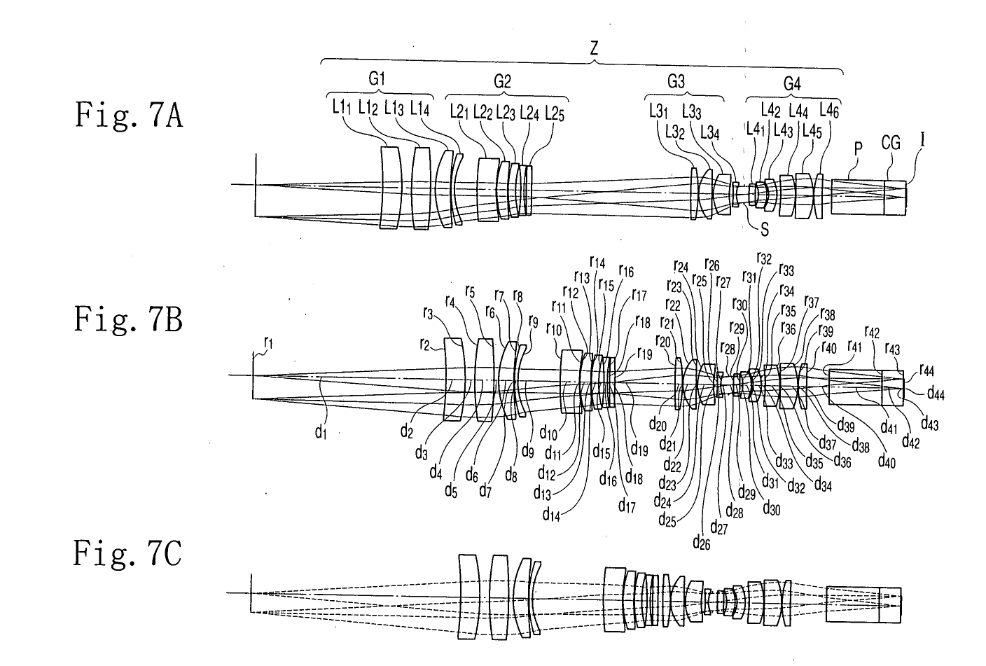

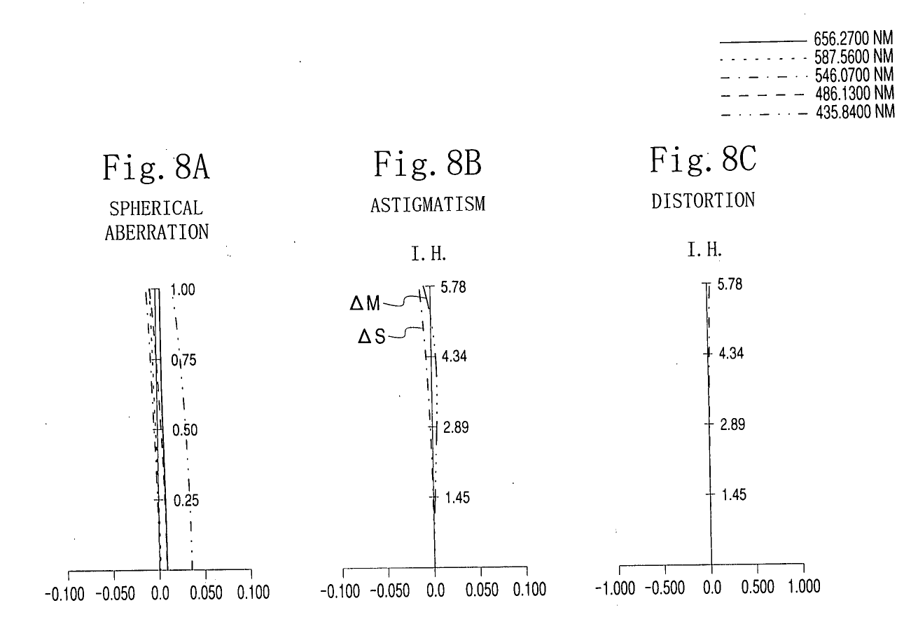

FIGS. 7A, 7B and 7C are sectional views taken along the optical axis to show the optical configuration of the fourth embodiment of the imaging optical system according to the present invention, showing the situations where the magnification is 0.3×, 0.4× and 0.5×, respectively. FIGS. 8A, 8B and 8C show spherical aberration, astigmatism and distortion, respectively, of the imaging optical system of the fourth embodiment under the condition where an object point at an infinite distance is in focus with the imaging magnification of 0.4×.

The imaging optical system of the first embodiment has a variable magnification optical system Z. In the drawings, the reference symbol P denotes a prism, the reference symbol CG denotes a cover glass, and the reference symbol I denotes an image pickup surface of an image pickup element.

The variable magnification optical system Z includes, in order from the object side toward the image side, a first lens unit G1 having a positive refractive power, a second lens unit G2 having a negative refractive power, a third lens unit G3 having a positive refractive power, an aperture stop S, and a fourth lens unit G4 having a positive refractive power.

The first lens unit G1 is composed of, in order from the object side, a positive meniscus lens L1₁ directing its concave surface toward the object side, a biconvex lens L1₂, a positive meniscus lens L1₃ directing its convex surface toward the object side, and a negative meniscus lens L1₄ directing its convex surface toward the object side.

The second lens unit G2 is composed of, in order from the object side, a negative meniscus lens L2₁ directing its convex surface toward the object side, a positive meniscus lens L2₂ directing its convex surface toward the object side, a negative meniscus lens L2₃ directing its convex surface toward the object side, a biconcave lens L2₄, and a biconvex lens L2₅.

The third lens unit G3 is composed of a biconvex lens L3₁, a positive meniscus lens L3₂ directing its convex surface toward the object side, a positive meniscus lens L3₃ directing its convex surface toward the object side, and a biconcave lens L3₄.

The fourth lens unit G4 is composed of a positive meniscus lens L4₁ directing its convex surface toward the object side, a negative meniscus lens L4₂ directing its concave surface toward the object side, a negative meniscus lens L4₃ directing its concave surface toward the object side, a positive meniscus lens L4₄ directing its concave surface toward the object side, a positive meniscus lens L4₅ directing its concave surface toward the object side, and a positive meniscus lens L4₆ directing its convex surface toward the object side.

In a magnification change from 0.3× through 0.5× under the condition where the object point at the infinite distance is in focus, the first lens unit G1 shifts toward the image side, the second lens unit G2 shifts toward the image side in such a manner that the distance thereto from the first lens unit G1 is widened, the third lens unit G3 shifts toward the object side, and the fourth lens unit G4 Shifts toward the image side along with the stop S.

Also, the object-image distance in the magnification change is kept constant.

Numerical data of the optical members constituting the imaging optical system according to the fourth embodiment are shown below.

Numerical data 4

| | | |
|---|---|---|
| r₀ = ∞ (object) | | |
| d₀ = 30.000 | | |
| r₁ = ∞ (object surface) | | |
| d₁ = D₁ | | |
| r₂ = −201.8942 | | |
| d₂ = 12.000 | nₑ₂ = 1.48915 | νₑ₂ = 70.04 |
| r₃ = −114.7549 | | |
| d₃ = 6.048 | | |
| r₄ = 150.1715 | | |
| d₄ = 12.000 | nₑ₄ = 1.43985 | νₑ₄ = 94.53 |
| r₅ = −277.4585 | | |
| d₅ = 2.941 | | |
| r₆ = 50.6636 | | |
| d₆ = 9.563 | nₑ₆ = 1.43985 | νₑ₆ = 94.53 |
| r₇ = 174.9746 | | |
| d₇ = 0.300 | | |
| r₈ = 71.2522 | | |
| d₈ = 2.163 | nₑ₈ = 1.61639 | νₑ₈ = 44.15 |
| r₉ = 42.1962 | | |
| d₉ = D₉ | | |
| r₁₀ = 175.1427 | | |
| d₁₀ = 12.000 | nₑ₁₀ = 1.77621 | νₑ₁₀ = 49.36 |
| r₁₁ = 81.4148 | | |
| d₁₁ = 0.300 | | |
| r₁₂ = 52.4026 | | |
| d₁₂ = 6.867 | nₑ₁₂ = 1.64419 | νₑ₁₂ = 34.2 |
| r₁₃ = 138.2091 | | |
| d₁₃ = 0.300 | | |
| r₁₄ = 64.4524 | | |
| d₁₄ = 4.622 | nₑ₁₄ = 1.77621 | νₑ₁₄ = 49.36 |
| r₁₅ = 57.8528 | | |
| d₁₅ = 3.320 | | |
| r₁₆ = −109.9394 | | |
| d₁₆ = 2.000 | nₑ₁₆ = 1.77621 | νₑ₁₆ = 49.36 |
| r₁₇ = 89.2309 | | |
| d₁₇ = 1.412 | | |
| r₁₈ = 334.0377 | | |
| d₁₈ = 3.374 | nₑ₁₈ = 1.64419 | νₑ₁₈ = 34.2 |
| r₁₉ = −1247.7308 | | |
| d₁₉ = D₁₉ | | |
| r₂₀ = 257.5961 | | |
| d₂₀ = 4.677 | nₑ₂₀ = 1.43985 | νₑ₂₀ = 94.53 |
| r₂₁ = −84.6326 | | |
| d₂₁ = 0.300 | | |
| r₂₂ = 22.5262 | | |
| d₂₂ = 8.288 | nₑ₂₂ = 1.43985 | νₑ₂₂ = 94.53 |
| r₂₃ = 1467.1655 | | |
| d₂₃ = 0.915 | | |
| r₂₄ = 24.6289 | | |
| d₂₄ = 9.938 | nₑ₂₄ = 1.43985 | νₑ₂₄ = 94.53 |
| r₂₅ = 39.4238 | | |
| d₂₅ = 2.473 | | |
| r₂₆ = −64.8469 | | |
| d₂₆ = 2.000 | nₑ₂₆ = 1.61639 | νₑ₂₆ = 44.15 |
| r₂₇ = 15.3218 | | |
| d₂₇ = D₂₇ | | |
| r₂₈ = ∞ (aperture stop) | | |
| d₂₈ = 3.000 | | |
| r₂₉ = 65.8007 | | |
| d₂₉ = 3.966 | nₑ₂₉ = 1.43985 | νₑ₂₉ = 94.53 |
| r₃₀ = 218.1401 | | |
| d₃₀ = 1.900 | | |
| r₃₁ = −17.0083 | | |
| d₃₁ = 5.341 | nₑ₃₁ = 1.43985 | νₑ₃₁ = 94.53 |
| r₃₂ = −17.4143 | | |
| d₃₂ = 1.139 | | |
| r₃₃ = −13.9217 | | |
| d₃₃ = 5.121 | nₑ₃₃ = 1.61639 | νₑ₃₃ = 44.15 |
| r₃₄ = −21.9164 | | |
| d₃₄ = 2.475 | | |
| r₃₅ = 69.6565 | | |
| d₃₅ = 9.117 | nₑ₃₅ = 1.43985 | νₑ₃₅ = 94.53 |
| r₃₆ = −36.4496 | | |
| d₃₆ = 0.300 | | |
| r₃₇ = −453.9892 | | |
| d₃₇ = 10.891 | nₑ₃₇ = 1.43985 | νₑ₃₇ = 94.53 |
| r₃₈ = −35.3189 | | |
| d₃₈ = 0.300 | | |
| r₃₉ = 45.1120 | | |
| d₃₉ = 5.158 | nₑ₃₉ = 1.43985 | νₑ₃₉ = 94.53 |
| r₄₀ = 491.8351 | | |
| d₄₀ = D₄₀ | | |
| r₄₁ = ∞ | | |
| d₄₁ = 33.000 | nₑ₄₁ = 1.61173 | νₑ₄₁ = 46.30 |
| r₄₂ = ∞ | | |
| d₄₂ = 13.200 | nₑ₄₂ = 1.51825 | νₑ₄₂ = 63.93 |
| r₄₃ = ∞ | | |
| d₄₃ = 0.500 | | |
| r₄₄ = ∞ (image pick-up surface) | | |
| d₄₄ = 0 | | |

| | | |
|---|---|---|
| 0.3× | 0.4× | 0.5× |

Zoom data

| | | | |
|---|---|---|---|
| D₁ | 49.925 | 91.290 | 101.857 |
| D₉ | 14.207 | 26.426 | 44.454 |
| D₁₉ | 99.472 | 37.528 | 3.000 |
| D₂₇ | 4.811 | 4.951 | 2.471 |
| D₄₀ | 5.825 | 14.044 | 22.457 |

Parameters in conditional expressions

| | | | |
|---|---|---|---|
| magnification: β | | | |
| entrance pupil position: En | −4542.364 | −3217.240 | −2392.972 |
| object-image distance: L | 407.450 | 407.450 | 407.450 |
| \|En\|/L | 11.148 | 7.896 | 5.873 |
| exit pupil position: Ex | −478.971 | −495.409 | −512.234 |
| \|Ex\|/\|L/β\| | 0.353 | 0.486 | 0.629 |
| FNO | 3.500 | 3.559 | 3.620 |
| variation of FNO: ΔFNO 0.120 | | | |
| \|ΔFNO/Δβ\| 0.600 | | | |

Fifth Embodiment

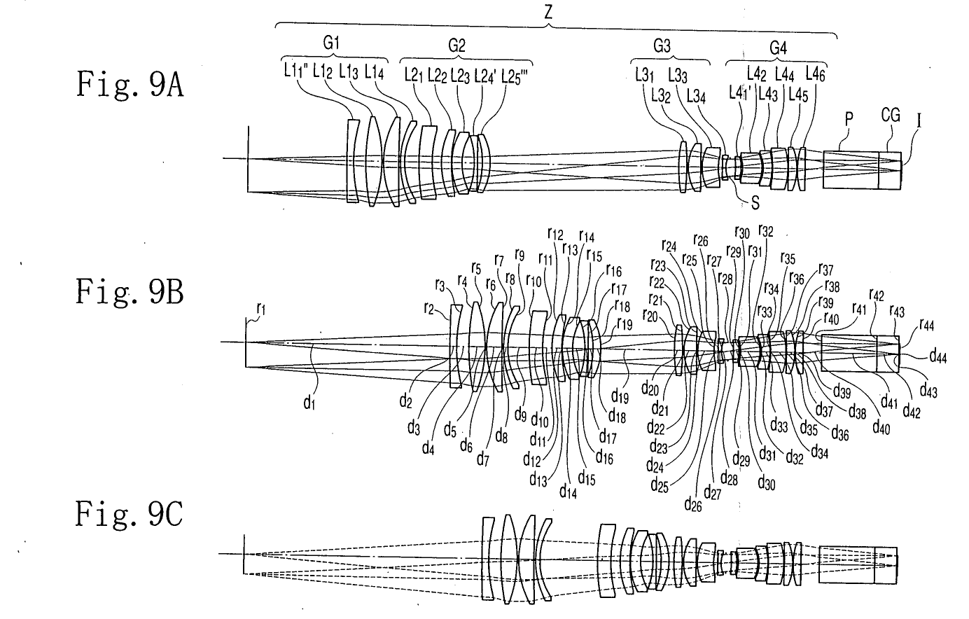

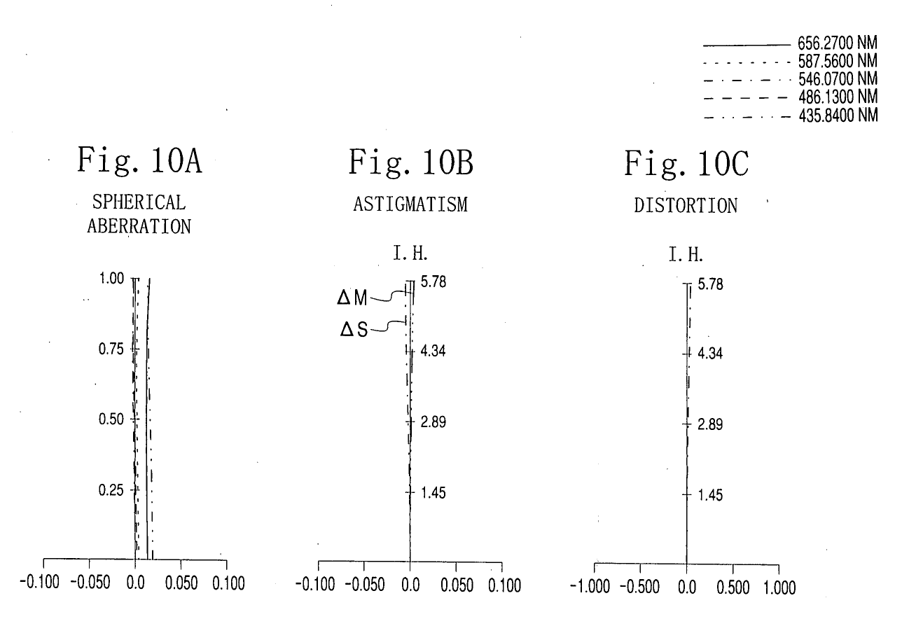

FIGS. 9A, 9B and 9C are sectional views taken along the optical axis to show the optical configuration of the fifth embodiment of the imaging optical system according to the present invention, showing the situations where the magnification is 0.3×, 0.4× and 0.5×, respectively. FIGS. 10A, 10B and 1° C. show spherical aberration, astigmatism and distortion, respectively, of the imaging optical system of the fifth embodiment under the condition where an object point at an infinite distance is in focus with the imaging magnification of 0.4×.

The imaging optical system of the fifth embodiment has a variable magnification optical system Z. In the drawings, the reference symbol P denotes a prism, the reference symbol CG denotes a cover glass, and the reference symbol I denotes an image pickup surface of an image pickup element.

The variable magnification optical system Z includes, in order from the object side toward the image side, a first lens unit G1 having a positive refractive power, a second lens unit G2 having a negative refractive power, a third lens unit G3 having a positive refractive power, an aperture stop S, and a fourth lens unit G4 having a positive refractive power.

The first lens unit G1 is composed of, in order from the object side, a negative meniscus lens L1₁ directing its convex surface toward the object side, a biconvex lens L1₂, a positive meniscus lens L1₃ directing its convex surface toward the object side, and a negative meniscus lens L1₄ directing its convex surface toward the object side.

The second lens unit G2 is composed of, in order from the object side, a negative meniscus lens L2₁ directing its convex surface toward the object side, a positive meniscus lens L2₂ directing its convex surface toward the object side, a negative meniscus lens L2₃ directing its convex surface toward the object side, a negative meniscus lens L2₄ directing its concave surface toward the object side, and a positive meniscus lens L2₅ directing its concave surface toward the object side.

The third lens unit G3 is composed of a biconvex lens L3₁, a positive meniscus lens L3₂ directing its convex surface toward the object side, a positive meniscus lens L3₃ directing its convex surface toward the object side, and a biconcave lens L3₄.

The fourth lens unit G4 is composed of a positive meniscus lens L4₁ directing its concave surface toward the object side, a negative meniscus lens L4₂ directing its concave surface toward the object side, a negative meniscus lens L4₃ directing its concave surface toward the object side, a positive meniscus lens L4₄ directing its concave surface toward the object side, a positive meniscus lens L4₅ directing its concave surface toward the object side, and a positive meniscus lens L4₆ directing its convex surface toward the object side.

In a magnification change from 0.3× through 0.5× under the condition where the object point at the infinite distance is in focus, the first lens unit G1 shifts toward the image side, the second lens unit G2 shifts toward the image side in such a manner that the distance thereto from the first lens unit G1 is widened, the third lens unit G3 shifts toward the object side, and the fourth lens unit G4 is fixedly positioned along with the stop S.

Also, the object-image distance in the magnification change is kept constant.

Numerical data of the optical members constituting the imaging optical system according to the fifth embodiment are shown below.

Numerical data 5

| | | |
|---|---|---|
| r₀ = ∞ (object) | | |
| d₀ = 30.000 | | |
| r₁ = ∞ (object surface) | | |
| d₁ = D₁ | | |
| r₂ = 666.7810 | | |
| d₂ = 4.034 | nₑ₂ = 1.61639 | νₑ₂ = 44.15 |
| r₃ = 86.4782 | | |
| d₃ = 7.343 | | |
| r₄ = 126.7192 | | |
| d₄ = 9.711 | nₑ₄ = 1.43985 | νₑ₄ = 94.53 |
| r₅ = −74.8133 | | |
| d₅ = 0.985 | | |
| r₆ = 52.2108 | | |
| d₆ = 9.130 | nₑ₆ = 1.43985 | νₑ₆ = 94.53 |
| r₇ = 725.6557 | | |
| d₇ = 1.007 | | |
| r₈ = 51.4865 | | |
| d₈ = 2.545 | nₑ₈ = 1.61639 | νₑ₈ = 44.15 |
| r₉ = 39.1565 | | |
| d₉ = D₉ | | |
| r₁₀ = 118.5095 | | |
| d₁₀ = 8.000 | nₑ₁₀ = 1.77621 | νₑ₁₀ = 49.36 |
| r₁₁ = 71.9827 | | |
| d₁₁ = 5.609 | | |
| r₁₂ = 46.3012 | | |
| d₁₂ = 5.910 | nₑ₁₂ = 1.64419 | νₑ₁₂ = 34.2 |
| r₁₃ = 69.9453 | | |
| d₁₃ = 0.300 | | |
| r₁₄ = 38.3300 | | |
| d₁₄ = 6.139 | nₑ₁₄ = 1.64419 | νₑ₁₄ = 34.2 |
| r₁₅ = 32.4940 | | |
| d₁₅ = 7.353 | | |
| r₁₆ = −47.1009 | | |
| d₁₆ = 2.000 | nₑ₁₆ = 1.77621 | νₑ₁₆ = 49.36 |
| r₁₇ = −588.7031 | | |
| d₁₇ = 2.882 | | |
| r₁₈ = −46.8444 | | |
| d₁₈ = 4.652 | nₑ₁₈ = 1.64419 | νₑ₁₈ = 34.2 |
| r₁₉ = −35.6242 | | |
| d₁₉ = D₁₉ | | |
| r₂₀ = 78.6906 | | |
| d₂₀ = 4.885 | nₑ₂₀ = 1.43985 | νₑ₂₀ = 94.53 |
| r₂₁ = −136.7293 | | |
| d₂₁ = 0.889 | | |
| r₂₂ = 25.6377 | | |
| d₂₂ = 7.512 | nₑ₂₂ = 1.43985 | νₑ₂₂ = 94.53 |
| r₂₃ = 1109.3730 | | |
| d₂₃ = 0.760 | | |
| r₂₄ = 24.9717 | | |
| d₂₄ = 9.712 | nₑ₂₄ = 1.43985 | νₑ₂₄ = 94.53 |
| r₂₅ = 29.8362 | | |
| d₂₅ = 2.505 | | |
| r₂₆ = −386.1761 | | |
| d₂₆ = 2.000 | nₑ₂₆ = 1.61639 | νₑ₂₆ = 44.15 |
| r₂₇ = 13.9540 | | |
| d₂₇ = D₂₇ | | |
| r₂₈ = ∞ (aperture stop) | | |
| d₂₈ = 3.290 | | |
| r₂₉ = −49.8811 | | |
| d₂₉ = 3.296 | nₑ₂₉ = 1.43985 | νₑ₂₉ = 94.53 |
| r₃₀ = −28.9220 | | |
| d₃₀ = 0.987 | | |
| r₃₁ = −18.1385 | | |
| d₃₁ = 11.620 | nₑ₃₁ = 1.43985 | νₑ₃₁ = 94.53 |
| r₃₂ = −19.5426 | | |
| d₃₂ = 0.807 | | |
| r₃₃ = −17.7427 | | |
| d₃₃ = 5.251 | nₑ₃₃ = 1.61639 | νₑ₃₃ = 44.15 |
| r₃₄ = −35.2631 | | |
| d₃₄ = 0.300 | | |
| r₃₅ = −57.2632 | | |
| d₃₅ = 9.207 | nₑ₃₅ = 1.43985 | νₑ₃₅ = 94.53 |
| r₃₆ = −39.3189 | | |
| d₃₆ = 0.300 | | |
| r₃₇ = −403.4911 | | |
| d₃₇ = 5.050 | nₑ₃₇ = 1.43985 | νₑ₃₇ = 94.53 |
| r₃₈ = 31.5353 | | |
| d₃₈ = .300 | | |
| r₃₉ = 1.6390 | | |
| d₃₉ = 4.600 | nₑ₃₉ = 1.43985 | νₑ₃₉ = 94.53 |
| r₄₀ = 1967.1674 | | |
| d₄₀ = 10.979 | | |
| r₄₁ = ∞ | | |
| d₄₁ = 33.000 | nₑ₄₁ = 1.61173 | νₑ₄₁ = 46.30 |
| r₄₂ = ∞ | | |
| d₄₂ = 13.200 | nₑ₄₂ = 1.51825 | νₑ₄₂ = 63.93 |
| r₄₃ = ∞ | | |
| d₄₃ = 0.500 | | |
| r₄₄ = ∞ (image pick-up surface) | | |
| d₄₄ = 0 | | |

| | | |
|---|---|---|
| 0.3× | 0.4× | 0.5× |

Zoom data

| | | | |
|---|---|---|---|
| D₁ | 29.450 | 92.787 | 113.264 |
| D₉ | 8.570 | 12.846 | 34.460 |
| D₁₉ | 113.055 | 44.074 | 3.000 |
| D₂₇ | 2.504 | 3.873 | 2.854 |

Parameters in conditional expressions

| | | | |
|---|---|---|---|
| magnification: β | | | |
| entrance pupil position: En | −1983.309 | 7822.021 | −2944.740 |
| object-image distance: L | 392.129 | 392.129 | 392.129 |
| \|En\|/L | 5.058 | 19.948 | 7.510 |
| exit pupil position: Ex | −360.404 | −360.404 | −360.404 |
| \|Ex\|/\|L/β\| | 0.276 | 0.368 | 0.460 |
| FNO | 3.500 | 3.499 | 3.499 |
| variation of FNO: ΔFNO −0.001 | | | |
| \|ΔFNO/Δβ\| 0.003 | | | |

Parameters in Conditional Expressions

| | magnification: β | | |
|---|---|---|---|
| | 0.3x | 0.4x | 0.5x |
| entrance pupil position: En | −1983.309 | 7822.021 | −2944.740 |
| object-image distance: L | 392.129 | 392.129 | 392.129 |
| \|En\|/L | 5.058 | 19.948 | 7.510 |
| exit pupil position: Ex | −360.404 | −360.404 | −360.404 |
| \|Ex\|/\|L/β\| | 0.276 | 0.368 | 0.460 |
| FNO | 3.500 | 3.499 | 3.499 |
| variation of FNO: ΔFNO | −0.001 | | |
| \|ΔFNO/Δβ\| | 0.003 | | |

The following Tables 1 and 2 show values of the parameters appearing in the conditional expressions and whether structural features satisfy the requirements of the present invention for the above embodiments.

TABLE 1

| | | 1st embodiment | 2nd embodiment | 3rd embodiment |
|---|---|---|---|---|
| object-side telecentricity | | | | |
| \|En\|/L | (β = 0.3) | 38814.21 | 0.80 | 3.85 |
| object-side telecentricity | | | | |
| \|En\|/L | (β = 0.4) | 72.17 | 0.75 | 3.82 |
| object-side telecentricity | | | | |
| \|En\|/L | (β = 0.5) | 6.11 | 0.75 | 2.24 |
| image-side telecentricity: | | | | |
| \|En\|/L/β\| | (β = 0.3) | 0.98 | 0.34 | 0.29 |
| image-side telecentricity: | | | | |
| \|En\|/\|L/β\| | (β = 0.4) | 1.63 | 0.52 | 0.92 |
| image-side telecentricity: | | | | |
| \|En\|/\|L/β\| | (β = 0.5) | 0.45 | 0.43 | 0.87 |

| | | | |
|---|---|---|---|
| conditions (1), (2) | ∘ | ∘ | ∘ |
| conditions (1′), (2′) | ∘ | x | ∘ |
| conditions (1″), (2″) | ∘ | x | x |
| difference in object-image | 0.00000 | 0.00000 | 0.00003 |
| distance between 0.3x and 0.5x | | | |
| brightest object-side F | 3.5 | 3.5 | 3.5 |
| number: MAXFNO | | | |
| \|ΔFNO/Δβ\| | 0.337 | 0.497 | 0.259 |
| conditions (3), (4) | ∘ | ∘ | ∘ |
| conditions (3′), (4′) | ∘ | ∘ | ∘ |
| conditions (3″), (4″) | ∘ | ∘ | ∘ |
| configuration of second lens | ∘ | ∘ | x |
| unit - negative meniscus | | | |
| configuration of second lens | ∘ | ∘ | x |
| unit - negative-positive | | | |
| configuration of second lens | ∘ | x | x |
| unit - | | | |
| negative-positive-negative | | | |

* ∘: condition satisfied,
x: condition unsatisfied.

TABLE 2

| | | 4th embodiment | 5th embodiment |
|---|---|---|---|
| object-side telecentricity | | | |
| \|En\|/L | (β = 0.3) | 11.15 | 5.06 |
| object-side telecentricity | | | |
| \|En\|/L | (β = 0.4) | 7.90 | 19.95 |
| object-side telecentricity | | | |
| \|En\|/L | (β = 0.5) | 5.87 | 7.51 |
| image-side telecentricity: | | | |
| \|En\|/L/β\| | (β = 0.3) | 0.35 | 0.28 |
| image-side telecentricity: | | | |
| \|En\|/\|L/β\| | (β = 0.4) | 0.49 | 0.37 |
| image-side telecentricity: | | | |
| \|En\|/\|L/β\| | (β = 0.5) | 0.63 | 0.46 |

| | | |
|---|---|---|
| conditions (1), (2) | ∘ | ∘ |
| conditions (1′), (2′) | x | x |
| conditions (1″), (2″) | x | x |
| difference in object-image | 0.00000 | −0.00007 |
| distance between 0.3x and 0.5x | | |
| brightest object-side F | 3.5 | 3.5 |
| number: MAXFNO | | |
| \|ΔFNO/Δβ\| | 0.600 | 0.003 |
| conditions (3), (4) | ∘ | ∘ |
| conditions (3′), (4′) | ∘ | ∘ |
| conditions (3″), (4″) | ∘ | ∘ |
| configuration of second lens | ∘ | ∘ |
| unit - negative meniscus | | |
| configuration of second lens | ∘ | ∘ |
| unit - negative-positive | | |
| configuration of second lens | ∘ | x |
| unit - | | |
| negative-positive-negative | | |

* ∘: condition satisfied,
x: condition unsatisfied.

The imaging optical system according to the present invention can be used for optical apparatuses such as a movie film scanner (telecine apparatus) and a height measurement apparatus. Embodiments of such applications are shown below as examples.

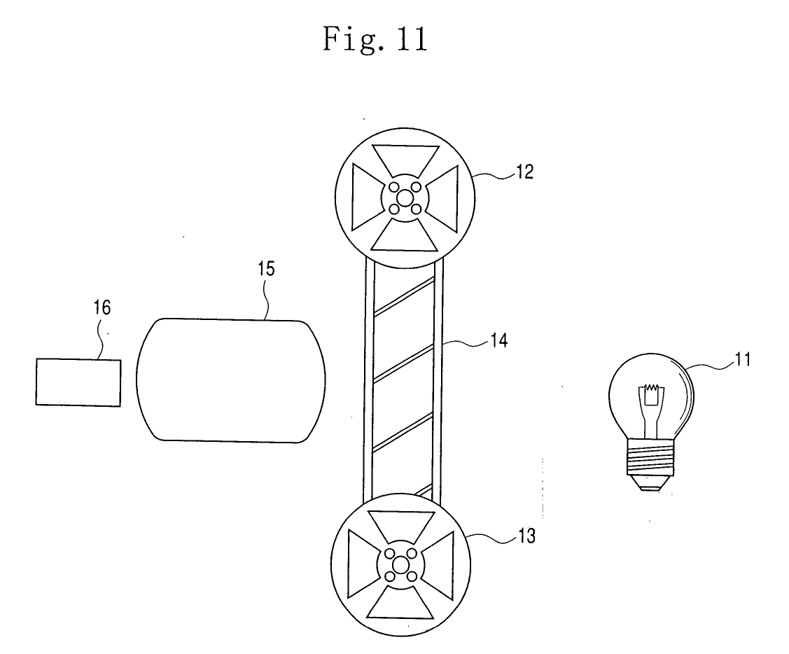

FIG. 11 is a schematic diagram that shows an embodiment of a telecine apparatus using the imaging optical system according to the present invention. The telecine apparatus of this embodiment is provided with a light source 11 for projecting a movie film, a movie film 14 reeled up on reels 12 and 13, an imaging optical system 15 having a configuration as shown in any of the embodiments of the present invention set forth above, and a CCD camera 16. In the drawing, a detained structure of the imaging optical system 15 is not shown.

In the telecine apparatus thus configured, light emanating from the light source 11 projects the film 14, and projected light is picked up by the CCD camera 16 via the imaging optical system 15.

In the imaging optical system 15, magnification can be changed in compliance with the size of the movie film 14 so that picture information on the movie film 14 is received on the full image pickup region of the CCD camera 16.

According to the telecine apparatus of this embodiment, the imaging optical system 15 is both-side telecentric with a conjugate length thereof being unchanged even if the imaging magnification is changed. Therefore, positional adjustment of each member is dispensable. Also, since fluctuation of the image-side F-number is small with a small loss of light amount, brightness adjustment also is dispensable. In addition, magnification variation on the image surface caused by disturbance of planeness of the object to be photographed can be made small.

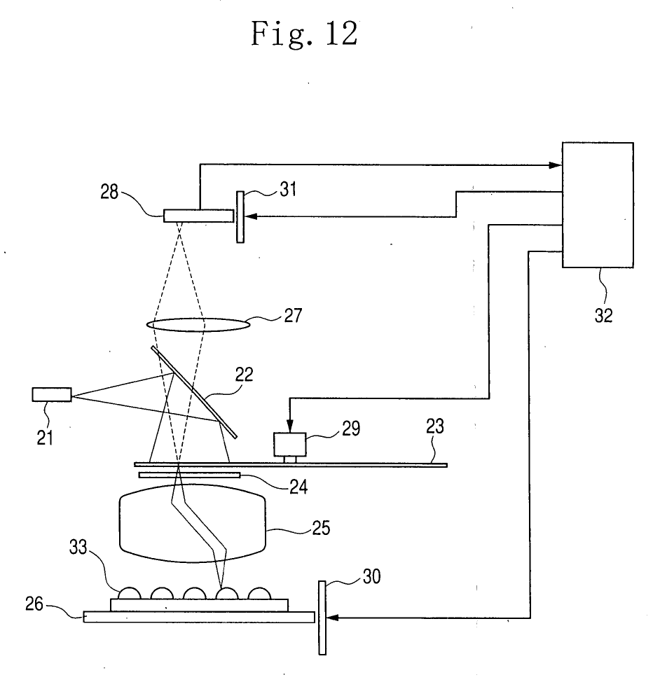

FIG. 12 is a schematic configuration diagram that shows one embodiment of a height measurement apparatus using the imaging optical system according to the present invention. In this embodiment, the imaging optical system is configured as a confocal optical system. The measurement apparatus of this embodiment is provided with a light source 21, a polarization beam splitter 22, a disc 23 provided with a plurality of pinholes, a λ/4 plate 24, a confocal optical system 25 configured similar to the imaging optical system shown in any of the embodiments above, an XYZ stage 26, an imaging lens 27, an image pickup element 28, a motor 29 that drives the disc 23, a stage driving system 30 that drives the XYZ stage, an image-pickup-element driving system 31 that drives the image pickup element 28, and a computer 32 that controls drive performance of the motor 29, the stage driving system 30 and the image-pickup-element driving system 31.

In the height detecting apparatus thus configured, out of light emanating from the light source 21, either one of linearly polarized, P- and S-components is reflected via the polarization beam splitter 22, passes a spot on the disc 23, is phase-shifted by 45 degrees through the λ/4 plate 24, and is incident on a certain point on a sample 33 on the XYZ stage 26 via the confocal optical system 24. Then, light reflected at the sample 33 passes the confocal optical system 25, is phase-shifted by 45 degrees through the λ/4 plate 24, passes the spot on the disc 23, is transmitted through the polarization beam splitter 22, and is picked up by the image pickup element 28 via the imaging lens 27. By driving the motor 29 via the computer 32, the entire surface of the sample 33 can be scanned. In this operation, height of the sample is detected by searching a position where light intensity of the confocal image of the sample 33 picked up by the image pickup element 28 is extreme as driving the driving system 30 or the driving system 31 in a direction of the optical axis.

Also, the magnification of the confocal optical system 25 is changeable in compliance with the size of the sample 33.

In the height detecting apparatus of this embodiment also, the confocal optical system 25 is both-side telecentric with the conjugate length being unchanged even if the magnification is changed. Therefore, positional adjustment of each member is dispensable. Also, since fluctuation of the image-side F-number is small with a small loss of light amount, brightness adjustment also is dispensable.

1. An imaging optical system comprising:
a variable magnification optical system comprising, in order from an object side:
a first lens unit having a positive refractive power;
a second lens unit having a negative refractive power;
a third lens unit having a positive refractive power;
a fourth lens unit having a positive refractive power; and
an aperture stop disposed between the third lens unit and the fourth lens unit,
wherein the variable magnification optical system changes an imaging magnification while keeping an object-to-image distance of the imaging optical system constant,
wherein a change of the imaging magnification is performed by changing a distance between the first lens unit and the second lens unit, a distance between the second lens unit and the third lens unit, and a distance between the third lens unit and the fourth lens unit, and
wherein the following conditions are satisfied in a change of the imaging magnification at least in one state of magnification:

|En|/L>0.4

|Ex|/|L/β|>0.4
where En is a distance from an object-side, first lens surface of the variable magnification optical system to an entrance pupil of the imaging optical system, L is the object-to-image distance of the imaging optical system, Ex is a distance from an image-side, last lens surface of the variable magnification optical system to an exit pupil of the imaging optical system, and β is a magnification of the entire imaging optical system.

2. An imaging optical system according to claim 1, satisfying the following conditions:
1.0<MAXFNO<8.0

|ΔFNO/Δβ|<5
where MAXFNO is a brightest object-side F-number in a change of the imaging magnification of the imaging optical system, ΔFNO is a difference between an object-side F-number under a minimum magnification of the imaging optical system as an entire system and an object-side F-number under a maximum magnification of the imaging optical system as an entire system, and Δβ is a difference between the minimum magnification of the imaging optical system as an entire system and the maximum magnification of the imaging optical system as an entire system.

3. An imaging optical system according to claim 1, wherein a most object-side lens of the second lens unit is a negative meniscus lens.

4. An imaging optical system according to claim 1, wherein the second lens unit comprises, on a most object side thereof, a negative lens and a positive lens arranged in order from the object side.

5. An imaging optical system according to claim 1, wherein the second lens unit comprises, in order from the object side, a negative lens, a positive lens and a negative lens.

6. An optical apparatus comprising:
the imaging optical system according to claim 1.
